(19) United States
(12) Patent Application Publication
(10) Pub. No.: US 2023/0321882 A1
(43) Pub. Date: Oct. 12, 2023

(54) CASTING MOLD FOR THE PRODUCTION OF A CASTING HAVING A FRONT AND A BACK FROM A HARDENABLE CASTING COMPOUND

(71) Applicant: Schock GmbH, Regen (DE)

(72) Inventors: Rudolf PATERNOSTER, Rinchnach (DE); Xaver PLEDL, Zwiesel (DE); Alois PROBST, Regen (DE)

(21) Appl. No.: 18/133,160

(22) Filed: Apr. 11, 2023

(30) Foreign Application Priority Data
Apr. 12, 2022 (DE) 10 2022 108 882.0

(51) Int. Cl. B29C 45/37; B29C 45/73

(52) U.S. Cl. CPC B29C 45/376; B29C 45/73; B29C 2045/7343; B29K 2821/00; B29K 2995/0015

(57) ABSTRACT

A casting mold for producing a casting having a front side and a rear side from a curable casting compound, including at least a first mold part shaping the front side and a second mold part shaping the rear side, the mold parts together delimiting a casting cavity. The first mold part has a first metal layer delimiting the casting cavity and the second mold part has a second metal layer delimiting the casting cavity. The two metal layers overlap in the region of their peripheries and at least the first metal layer is heatable by way of an assigned heating device. An insulation element is arranged on the metal layer of the first or of the second mold part in a peripherally encircling manner. The insulation element in the closed position bears peripherally against the other metal layer and thermally separates the two metal layers, which do not come into contact with one another, from one another.

### CROSS-REFERENCE TO RELATED APPLICATIONS

The present application claims priority of DE 10 2022 108 882.0, filed Apr. 12, 2022, the priority of this application is hereby claimed, and this application is incorporated herein by reference.

### BACKGROUND OF THE INVENTION

The invention relates to a casting mold for producing a casting having a front side and a rear side from a curable casting compound, comprising at least a first mold part shaping the front side and a second mold part shaping the rear side, said mold parts together delimiting a casting cavity, wherein the first mold part has a first metal layer delimiting the casting cavity and the second mold part has a second metal layer delimiting the casting cavity, wherein the two metal layers overlap in the region of their peripheries and at least one metal layer is heatable by way of an assigned heating device.

Such a casting mold, as is known for example from EP 1 237 694 B1, is used to produce castings from a curable casting compound which preferably comprises a polymer matrix and fillers introduced therein for producing composite castings. An example of castings that can be produced here are kitchen sinks which have a correspondingly complex, three-dimensional shape which is mapped by way of the casting cavity or the shape of the two metal layers. However, other castings such as washbasins, shower trays and the like may also be produced by way of such a casting mold.

To produce the casting, the casting compound is introduced into a casting cavity which is delimited by way of two mold parts. The first mold part is used to shape the front side of the casting, and the second mold part is used to shape the rear side. In this case, each mold part has a metal layer, that is to say a shape-imparting, thin metal sheet which directly delimits the casting cavity at the front and rear, that is to say is directly shape-imparting. The casting compound consequently bears against these two metal layers.

The casting compound is a curable reaction compound, for example a reaction compound based on polyacrylate or polymethacrylate. The reaction compound is introduced into the casting cavity under a pressure of several bar in order to ensure that said cavity is filled completely, after which the polymerization process is started. In this regard, in the casting mold known from EP 1 237 694 B1, the first metal layer forming the front side is heated over the entire metal layer surface by means of a heating device assigned thereto, such that the casting compound, which, as already mentioned, bears against the first metal layer, is inevitably also heated. If the casting compound is heated above the polymerization start temperature, the exothermic polymerization reaction begins, the polymerization front moving successively through the casting compound to the opposite second metal layer. Any shrinkage occurring here can be countered by virtue of the fact that the metal layer forming the rear side is movable, such that the volume of the casting cavity can be adapted to the shrinkage.

In the case of the casting mold known from EP 1 237 694 B1, the two metal layers bear against one another peripherally in an areal manner, the casting cavity being sealed toward the side by way of this abutment, in conjunction with an encircling sealing element. If the first metal layer is heated, an outflow of heat into the second metal layer occurs as a result of the peripheral abutment, which has the effect that the first metal layer is not heated in the peripheral region to the same extent as over the surface, and the temperature in the peripheral region is somewhat lower. This in turn has the effect that the casting compound located peripherally in the casting cavity is also heated to a less pronounced extent than in the region of the areal abutment of the casting compound against the first metal layer. While the polymerization reaction may have already started in this areal region, it has conversely not yet begun in the peripheral region. This may in turn have the effect that the casting compound in the cavity volume polymerizes to completion, that is to say cures, more rapidly than at the periphery. While the casting compound within the volume is thus able to completely polymerize, the polymerization reaction in the peripheral region runs in a delayed manner in comparison, meaning that the casting compound in the peripheral region may still be at least partially liquid while it has cured within the volume. Since, on account of the metal layers lying fixedly against one another, there is also no shrinkage compensation provided in the peripheral region in the absence of any given movability of one of the metal layers, it may ultimately be the case that, during the curing of the casting compound in the peripheral region, shrinkage-induced imperfections form as a result of the delayed polymerization, which consequently has an adverse effect on the final molding.

### SUMMARY OF THE INVENTION

The invention is therefore based on the problem of specifying a casting mold which is improved in comparison.

To solve this problem, provision is made according to the invention, in the case of a casting mold of the type mentioned in the introduction, for an insulation element to be arranged on the metal layer of the first or of the second mold part in a peripherally encircling manner, said insulation element in the closed position bearing peripherally against the other metal layer and thermally separating the two metal layers, which do not come into contact with one another, from one another.

According to the invention, one of the two metal layers is furnished with a peripherally encircling insulation element by way of which, in the closed position, the two metal layers are thermally separated from one another, that is to say insulated. In the case of the casting mold according to the invention, the metal layers no longer bear against one another, but rather an insulation plane is integrated by way of the insulation element and effectively prevents an outflow of heat from the heated first metal layer to the second metal layer in the peripheral region or bearing region. The advantageous thermal insulation has the effect that a corresponding, defect-free and temporally consistent polymerization reaction can also occur in the peripheral region, since a sufficient heat input to start the polymerization is possible by way of the heated metal layer. The for example rectangular encircling insulation element, which may also be composed of individual element portions that supplement one another in encircling fashion, projects to some extent on the peripheral surface of the metal layer on which the insulation element is arranged, with the result that, when the mold parts are closed, said insulation element inevitably runs against the peripheral abutment surface of the other metal element.

Preferably, a heating device is also assigned to the second metal layer and can be used to heat the second metal layer separately. The casting mold according to the invention therefore has two separate controllable heating devices, such that the first and the second metal layer can be heated separately. This makes it possible for the first and the second metal layer to be heated with different temperature profiles, as far as both the actual temperature and the temporal profile are concerned. A further control possibility lies in the fact that the one or each heating device may have a plurality of separate heating circuits, such that different temperature profiles can also be operated as seen locally over the heating device, and thus locally individual heating is possible. This makes it possible for the one or both heating devices to ultimately be controlled in dependence on the reaction kinetics. It is conceivable for a respective separate peripheral heating circuit to be provided for example on one or on both heating devices, such that heating in the peripheral region can be performed for example sooner or more strongly and polymerization can be initiated sooner, or the like, that is to say for heating to just be performed in dependence on the reaction kinetics.

As described, the two metal layers are thermally insulated in relation to one another by way of the insulation element, that is to say that they are not in thermally conductive contact. In this case, the insulation element may also perform a support function in that the two metal layers are also supported in relation to one another by way of the insulation element. This means that ultimately the two mold parts are supported in relation to one another by way of the insulation element.

The insulation element itself is preferably composed of a material having a thermal conductivity<10 W/(m×K), wherein a plastic is preferably suitable as material. The use of a plastic, which inevitably has a certain degree of elasticity or flexibility or softness, also has the advantage, in addition to the thermal insulation capacity thereof, that any irregularities of the metal layer peripheries can also be compensated by way of the plastics insulation element. The insulation element thus permits a complete, entirely gap-free closure of the casting cavity, meaning that no microgaps, which lead to casting defects that require postprocessing, are formed in the peripheral region, as may however be the case with a casting mold according to EP 1 237 694 B1. Since the integration of the insulation element avoids any contact between the two metal layers, a risk of injury on the visible contact edge that is posed in the case of such direct layer contact can be reduced.

The plastics insulation element used is preferably a thermoplastic, a thermoset or an elastomer. By way of example, the insulation element may be composed of polyoxymethylene (POM) or a polyester urethane rubber or polyurethane elastomer, such as obtainable under the trade name “Vulkollan®”, this being only one example. It is of course also possible to use other plastics, provided that they have the desired properties.

One of these properties is the hardness of the insulation element or of the material used. This should have a Shore A hardness of 80-100, in particular of Shore A 90.

The insulation element itself is preferably in the form of a strip and has a rectangular cross section. The two metal layers have corresponding planar abutment surfaces, such that use of such a strip-like, wide insulation element provides a sufficient abutment surface which is large on both sides and via which the load is also distributed sufficiently so that the surface pressure can be correspondingly reduced.

The fixing of the insulation element may be effected, for example, simply by adhesive bonding to the metal layer. As an alternative or in addition, the mounting may also be effected by means of one or more clamping elements such as clamping strips or the like.

This is also taken into account by the configuration of the invention in which the peripheral region of the metal layer against which the insulation element is placed during the closing operation is of stepped embodiment, and has a first bearing region against which the insulation element first runs and a second bearing region against which the insulation element, pinched between the first bearing region and the metal layer bearing the insulation element, runs after the deformation thereof. This means that ultimately a metal layer has two separate, stepped bearing surfaces in the bearing region, these two bearing surfaces or bearing regions lying offset by 0.2-2 mm, in particular by about 0.5 mm, relative to one another. During the closing operation, the insulation element consequently first runs against the first, virtually protruding bearing region. As the closing movement and load increases, the insulation element is pinched to some extent, that is to say the surface pressure increases. As the closing movement progresses and thus the load increases, the insulation element then runs against the second areal bearing region, in which it is additionally supported, and the overall surface pressure is sufficiently reduced by way of the two supporting regions or supporting surfaces.

Although it is conceivable, in principle, for the overall sealing of the casting cavity at the peripheries to be realized by way of the insulation element, which as described is preferably composed of plastic and has a corresponding elasticity or flexibility, it is also conceivable for an encircling sealing element which bears against the insulation element in the closed position to be provided on the metal layer against which the insulation element runs during the closing operation. This means that the exposed abutment surface of the metal layer against which the insulation element runs is additionally furnished with a sealing element, which realizes an additional sealing plane in the direction of the insulation element. The sealing element itself is preferably received in a groove formed between the first and the second bearing region. The sealing element is, for example, a sealing rubber composed of a corresponding plastics material, in turn preferably an elastomer. During the closing operation, the insulation element consequently runs against this sealing element, such that said sealing element bears with pressure against the insulation element.

As described, heat is coupled in in a large-area manner and over the entire metal layer surface by way of the areal heating device assigned to the first metal layer, or, if provided, by way of the areal heating device assigned to the second metal layer. In order for this to be carried out as efficiently as possible, the or each areal heating device may be arranged directly on the rear side of the respective metal layer and may cover the rear side as far as the peripheral region of overlap. This means that the heating device also extends into the region in which the two metal layers peripherally overlap and are thermally separated from one another byway of the insulation element. This in turn has the effect that an active heat input can inevitably also be effected directly in the peripheral region of the casting cavity, and possibly even somewhat beyond that peripherally as far as the metal layers are concerned.

The, one of the two, or each heating device may have tubular or band-like heating elements which are embedded in a thermally conductive compound. The tubular heating elements are, for example, heating tubes or heating coils through which hot water or another heating fluid is flushed. As an alternative, band-like heating elements in the form of electrical heating conductors may also be provided. These heating elements are fundamentally embedded in an appropriate thermally conductive compound which makes it possible for this heating device to be laid corresponding to the three-dimensional shape of the first or alternatively of the second metal layer, such that it can be adapted precisely. At least the heating elements of the heating device, which is movable by way of an elastic intermediate layer, this being discussed further below, may be embedded into a thermally conductive compound which is additionally also elastic.

The compound is preferably a thermally conductive compound, via which the heat introduced by way of the heating elements can be distributed in an optimally homogeneous manner over the surface. This thermally conductive compound may be a polymer compound comprising embedded metal particles, especially copper particles.

The heating elements themselves, of whatever kind, may be introduced in the elastic compound or thermally conductive compound for example in a meandering form, helical form or in other geometries, wherein a plurality of separate heating circuits may also be formed by way of heating tubes or heating conductors which can be supplied or energized separately, such that different temperature profiles can also be operated locally and temporally and the heat input can be controlled more flexibly.

In this case, it is in particular conceivable for the heating elements of the or each heating device to be laid more closely in the peripheral region of overlap than in the rest of the region. Since, as described, the supporting of the metal layers means no notable movability of the metal layer is provided in the peripheral region when a movable metal layer is provided for shrinkage compensation, any non-compensated polymerization shrinkage may, as described, result in material defects such as matted areas or shrinkage marks, since there is a lack of a corresponding downward pressure of the casting compound from the volume which has already polymerized to completion. This can be counteracted, as described, by the integration of the insulation element, but also additionally by making a higher energy input in the peripheral region possible by laying the heating elements more closely in the peripheral region. This means that the heating tubes or heating conductors in the peripheral region, in which the two metal layers thus lie one above the other and are supported by way of the insulation element, run so as to lie closer to one another than over the rest of the heating element surface. This has the effect that the casting compound in the peripheral region even cures slightly sooner than within the rest of the volume, such that a corresponding downward pressure is effected by the surrounding, pressurized and still liquid casting composition, and shrinkage compensation may accordingly also occur in the peripheral region. A separate heating circuit may also be provided in encircling fashion in the peripheral region, such that a specific heat input may be effected locally at the periphery and the peripheral polymerization may be initiated sooner.

The two metal layers are expediently formed from nickel, that is to say from a nickel sheet of corresponding size. In this case, the first metal layer may have a thickness of 3-7 mm, in particular of 4-6 mm and preferably of 5 mm. The second metal layer is preferably somewhat thinner, and has a thickness of 1-3 mm, preferably of 2 mm. The first metal layer may be selected to be somewhat thicker, since it is positionally fixed and a corresponding metal volume ensures a homogeneous heat distribution. This is because, as described, the polymerization operation is regularly initiated by an initial heat input from the front side, that is to say by way of the first metal layer. The second metal layer is thinner in comparison, since it needs to be movable and thus must not be selected to be too thick and therefore too stiff.

Expediently, the casting mold has at least one metal layer which is at least partially deformable for the purpose of changing the casting cavity volume. This can be used, when required depending on the casting to be produced, to compensate for shrinkage-induced loss, in that the movable metal layer performs tracking. Here, the effectiveness of the insulation element is particularly advantageously shown. This is because the possibility of compensating for shrinkage by way of the variation of the casting cavity volume ensures that, in spite of the reaction-induced shrinkage, the fluid compound pushes down in the peripheral region and can polymerize optimally there, such that a geometrically precise peripheral formation is made possible which requires no or only negligible mechanical postprocessing, as is however the case for mold parts produced using a casting mold according to EP 1 237 694 B1. Consequently, the formation of imperfections such as holes or matted areas does not occur in the peripheral region, and also no peripheral geometries requiring postprocessing are formed.

In this case, the mold part having the movable metal layer may have an areal intermediate layer which is composed of an elastically deformable and compressible material and against which the metal layer of the mold part is movable with build-up of a restoring force on the part of the deforming intermediate layer. By way of this elastic and compressible intermediate layer which is supported on a mold park carrier and which is preferably composed of an elastic, compressible plastics material such as a foam rubber, a tracking or restoring device is integrated directly in the mold part, without any additional, external components, such as provided in the prior art according to EP 1 237 694 B1, being required for this. In the case of the casting mold from EP 1 237 694 B1, the metal layer is moved by way of a pressure fluid, which is introduced into a cavity behind the movable metal layer by way of pipelines and a pump. All this is not necessary in the case of the casting mold according to the invention, since the integrated areal intermediate layer is correspondingly deformable with build-up of a restoring force. If the casting compound is consequently introduced into the casting cavity at high pressure, which is usually about 4-5 bar, the movable metal layer pushes against the elastic, compressible intermediate layer and deforms it, and the layer builds up a restoring force. If shrinkage occurs, the intermediate layer pushes the metal layer down, such that permanent abutment of the metal layer against the casting compound is provided. Accordingly, the casting cavity is gradually made smaller, so as to follow the shrinkage of the casting compound polymerizing to completion. A permanent areal abutment of the casting compound against the corresponding metal layer is thus ensured.

For this purpose, a layer of foam rubber is preferably used. Foam rubber refers to a largely closed-pore, elastic foam. Such a sponge rubber may be produced, for example, from chloroprene, natural rubber, acrylonitrile butadiene rubber or comparable synthetic rubbers such as styrene-butadiene rubber, ethylene propylene diene rubber or similar rubbers, this enumeration not being exhaustive. Such an elastic plastics material, in particular in the form of a foam rubber, lends itself in particular with regard to the embodiment thereof as a relatively large intermediate layer, which is also able to be shaped in a simple manner so as to correspond to the three-dimensional shape of the metal layer and accordingly is able to be integrated into the mold part. In principle, the intermediate layer material used should have a Shore A hardness of 5°-35°, preferably of 15°+/−5°. The intermediate layer should have a thickness of 2-10 mm, in particular of 3-7 mm and preferably of 4-6 mm, and should preferably cover the entire surface with which the metal layer delimits the casting cavity.

The intermediate layer itself preferably covers the entire surface with which the second metal layer delimits the casting cavity. This means that the elastic intermediate layer extends over the entire region with which the metal layer comes into contact with the casting compound, that is to say runs up to the peripheries or up to the periphery with which the mold part bears against the other mold part. This ensures that corresponding tracking of the metal layer, said tracking being quasi-active because it results from the built-up restoring force, ultimately occurs in all regions.

The metal layer is preferably the second metal layer of the second mold part, since the second metal layer is used to form the rear side of the casting, said rear side generally not being visible in the assembled position for example of a kitchen sink. Provision may be made in a refinement of the invention for the heating device which covers the rear side of the second metal layer in an areal manner and which bears against the areal intermediate layer to be provided directly on said rear side. This heating device on the second metal layer can also be used to perform heating from the rear side in a targeted manner, in order to control the polymerization process. In order to be able to optimally couple the heating power into the second metal layer, this heating device bears against the second metal layer in an areal manner. According to the invention, the heating device is then followed by the areal, elastic intermediate layer, which is supported in turn so that it has a counterbearing with respect to the compression. This means that, according to the invention, the second metal layer is coupled in terms of movement to the elastic intermediate layer virtually indirectly by way of the heating device.

The insulation element may also be designed with a non-adhering property in relation to the reaction compound. This ensures that neither the reaction compound, that is to say the casting compound, nor the completely polymerized moulding adheres to the insulation element, which could possibly lead to imperfections. This non-adhering property may be provided for example by the material of the insulation element itself, or for example by a corresponding surface coating of the insulation element.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

FIG. 1 shows a diagrammatic illustration of a casting mold according to the invention,

FIG. 2 shows an enlarged partial view of region II from FIG. 1, and

FIG. 3 shows an enlarged partial view of region III from FIG. 1.

### DETAILED DESCRIPTION OF THE INVENTION

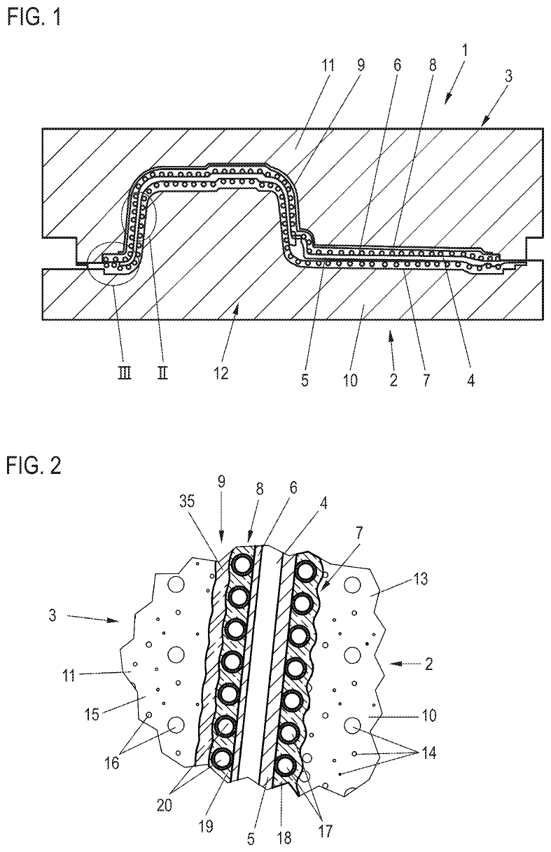

FIG. 1 shows a diagrammatic illustration of a casting mold 1 according to the invention which is used to produce a casting, having a front side and a rear side, in the form of a kitchen sink consisting of a composite material. The casting mold comprises a first mold part 2 which is used to shape or define the front side of the casting to be produced, and a second mold part 3 which is used to shape or define the rear side of the casting to be produced. Both mold parts lie peripherally against one another and delimit a casting cavity 4 into which a casting compound 5 consisting of a curable polymer compound, that is to say a reaction compound, into which particulate fillers such as quartz sand and the like are introduced, is introduced. While the first mold part 2 is regularly positionally fixed, the second mold part 3 can be moved vertically, that is to say can be placed onto the lower first mold part 2 for the purpose of closing the casting cavity 4.

The casting cavity 4 itself is delimited by a first metal layer 5, which is arranged on the first mold part 2, and a second metal layer 6, which is arranged on the second mold part 3. The introduced casting compound comes into contact with these two metal layers 5, 6, that is to say bears against these two metal layers 5, 6 in an areal manner. In this case, a first heating device 7, which covers the rear side of the first metal layer in a virtually full-area manner, is arranged on the rear side of the first metal layer 6. This heating device can be used to control the temperature of the first metal layer 5, and said first metal layer can be used to heat the casting compound from the front side. The second mold part 3 also has a second heating device 8 which is arranged on the rear side of the second metal layer 6, so as to ultimately cover it in a full-area manner. The second heating device 8 can be used to control the temperature of the second metal layer 6, and said second metal layer can be used to control the temperature of the casting compound, consequently it is thus possible to control the heat input into the casting compound from the rear side. The second heating device 8 is followed by an elastic and compressible intermediate layer 9, preferably composed of a foam rubber, said intermediate layer thus constituting a restoring means or restoring element which makes a certain degree of movability of the second metal layer 6 possible and which at the same time ensures that the second metal layer 6 can be returned back into a defined starting position. The function of the elastic, compressible intermediate layer 9 is discussed in even greater detail below with reference to FIG. 2.

Furthermore, the first mold part 2 has a first mold part carrier 10 against which, in turn, the first heating device 7 bears. The second mold part 3 also has a second mold part carrier 11 against which the elastic, compressible intermediate layer 9 bears. Both mold part carriers 10, 11 are preferably at least partially composed, insofar as the metal layers are supported thereon, of a polymer concrete.

FIG. 2 shows an enlarged view of region II from FIG. 1, illustrating the mutually opposite regions of the first mold part 2 and of the second mold part 3 with formation of the casting cavity 4. Shown on the right is the first mold part 2 with its mold part carrier 10 composed of the polymer concrete, consisting of a polymer matrix 13 comprising fillers embedded therein, for example gravel or sand particles and the like. The mold part carrier 10 is followed by the first heating device 7, consisting of tubular heating elements 17 which are guided, for example, in a meandering form or as heating coils and the like and which are embedded in a thermally conductive compound 18. In this case, a temperature-controlled heating fluid such as water flows through the heating elements 17. As an alternative thereto, electrical heating bands or the like may also be provided as heating elements 17.

Arranged on the heating device 7, in direct contact therewith, is the first metal layer 5 which is a nickel sheet for example having a thickness of 5 mm. As is apparent, this first metal layer 5 directly delimits the casting cavity 4.

Also shown is a detail of the second mold part 3 with its mold part carrier 11, likewise consisting of a polymer matrix 15 comprising fillers 16 embedded therein, again in the form of gravel or sand particles, etc. This mold part carrier 11 is followed by the elastic, compressible intermediate layer 9 which is formed from a foam rubber 35, that is to say from an elastic and compressible foamed plastics material. A foam rubber 35 is a largely closed-pore, elastic foam, that is to say a sponge rubber, which consists of a foamed rubber material. This elastic, compressible intermediate layer 9 has a thickness preferably of about 4 mm, and a Shore A hardness of 5°-35°, preferably of A 15°+/−5°. The second heating device 8 is connected to the mold part carrier 11 by way of this elastic intermediate layer 9, wherein here the second heating device 8 also consists of a thermally conductive compound 19 comprising heating elements 20 in the form of heating tubes which are embedded therein and which, like the tubular heating elements 17, are for example copper tubes and are likewise flowed through by a heating fluid. It is true of both thermally conductive compounds 18, 19 that they are elastic, that is to say flexible, such that the areal or mat-like heating devices 7, 8 can be laid so as to follow the three-dimensional shape of the respective mold part carrier 10, 11 without any problems.

Lastly, the second metal layer 6 is arranged on the heating device 8, said second metal layer likewise being a nickel sheet but which only has a thickness of about 2 mm, which is necessary since this second metal layer 6 is movable, that is to say the position thereof changes during the actual production. This is made possible by virtue of the fact that the second metal layer 6, together with the second heating device 8, can be moved, that is to say the position thereof can change, relative to the second mold part carrier 11 by way of the elastic and compressible intermediate layer 9.

If a casting operation is commenced, the second metal layer 6 is in its starting position, and the casting cavity 4 has a defined starting volume. The second metal layer 6 is at a defined spacing to the first metal layer 5, and the intermediate layer 9 is relaxed and only compressed to a slight extent, if at all. At the beginning of the casting operation, the casting compound, which may be a sufficiently flowable compound based on polyacrylate or polymethacrylate, is introduced into the casting cavity 4 at pressure. The casting pressure lies in the range of about 2-5 bar. As a result of this notably high pressure within the casting cavity 4, which is necessary in order to ensure that the casting compound is distributed throughout the casting cavity 4, a correspondingly high surface pressure builds up in the direction of the two metal layers 5, 6. The position of the first metal layer 5 does not change, since it is supported directly on the first mold part carrier 10. By contrast, the second metal layer 6 evades the pressure which is building up. As a consequence of the pressure, the elastic intermediate layer 9 is compressed here, that is to say it is compressed over the entire surface thereof, which is possible since it is supported, in turn, on the positionally fixed second mold part carrier 11. This means that the casting cavity volume can be increased due to the high injection pressure, resulting from a movement of the second metal layer 6 against the elastic, compressible intermediate layer 9 or the foam rubber 35, which is compressed here with build-up of a restoring force.

The polymerization process is then initiated, which is regularly effected by actuating the first heating device 7, thus consequently a heating fluid circulates through the heating elements 17. Homogeneous heating of the heating device 7 and, by way of the latter, of the first metal layer 5 occurs here. Said first metal layer then, in turn, heats the casting compound in the casting cavity 4, said casting compound increasing in volume to some extent as a consequence of the temperature, which leads to further compression of the elastic intermediate layer 9 since the internal pressure in the casting cavity 4 is increased further by this increase in volume of the casting compound.

If the local heating at the interface to the first metal layer 5 is so great that a polymerization start temperature is reached, the exothermic polymerization reaction begins at this interface, that is to say that the polymer matrix is polymerized to completion, wherein this polymerization front gradually migrates into the casting compound, that is to say moves in the direction of the second metal layer 6. In this case, the temperature of the second metal layer 6 is also controlled in due course by way of the second heating device 8, in order to consequently also control the polymerization reaction from this side. This means that the polymerization reaction is also initiated from this side, in accordance with a defined time schedule. Since, as described, the polymerization reaction is exothermic, it progresses automatically within the volume.

However, the polymerization is also accompanied by shrinkage of the casting compound or of the polymerized casting being produced, thus consequently by a reduction in volume. In order to nevertheless ensure that the casting compound or the completely polymerized outer skin of the casting is always in contact both with the first metal layer 5 and with the second metal layer 6, the second metal layer 6, which has previously moved out of its starting position with compression of the elastic intermediate layer 9, is then automatically restored, that is to say tracks the polymerization shrinkage, by way of the elastic intermediate layer 9 which is relaxing or increasing in size. The intermediate layer 9 has, as described, built up a restoring force during the compression. If the internal pressure in the casting cavity 4 then decreases as a result of the compound shrinkage, the compressed elastic intermediate layer 9 can relax again, that is to say the volume thereof increases again and continuously pushes the second metal layer 6 back in the direction of its starting position, such that continuous contact between the second metal layer 6 and the casting compound or the casting is accordingly provided.

Due to the integration of the intermediate layer 9, the second mold part 3 is accordingly of automatically adjusting or self-adjusting embodiment, without any additional external elements being necessary for the required movement of the second metal layer 6. Rather, an automatic restoring device is provided by way of the integrated intermediate layer 9, that is to say the foam rubber layer, the operation of said restoring device requiring no actuating means or other elements. Rather, inherent control is effected exclusively by way of the internal pressure in the casting cavity 4 and thus ultimately by way of the casting compound or the polymerization operation thereof itself.

The heating or operation of the two heating devices 7, 8 is correspondingly controlled in the course of the production method. The polymerization is, as described, started from the visible side, that is to say from the first mold part 2, and thus by way of the first heating device 7. In this case, the tubular heating elements 17 are either laid, or divided into groups that are correspondingly separately heatable, in such a way that heating is initially effected at the encircling outer periphery of the mold cavity 4 so that the polymerization reaction first starts there, since the second metal layer 6 is movable only to a negligible extent, if at all, directly at the periphery, for which reason polymer shrinkage cannot be compensated there, as is however the case within the volume.

However, since the casting compound within the volume is still fluid while the polymerization has already started at the periphery, the shrinkage compensation can be effected by way of the casting compound volume. This means that locally different temperature control is ultimately possible by way of the first heating device 7.

The heating by way of the second heating device 8, that is to say from the second mold half, may be effected with a time delay, for example only after several minutes, example after about five minutes, that is to say when the polymerization has already started at the periphery and possibly also on the side of the first metal layer 5. This accordingly means that both a local heating profile and a temporal heating profile may be operated individually, ultimately in dependence on the reaction kinetics.

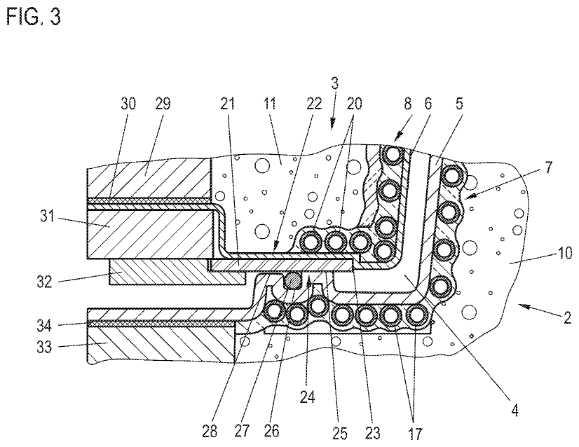

FIG. 3 shows an enlarged partial view of region III from FIG. 1. This region shows the region in which the lower mold part 2 shaping the front side abuts against the upper mold part 3 shaping the rear side. Shown in a detail are the respective mold part carrier 10, 11, the respective heating device 7, 8 and the two metal layers 5, 6, which lie one above the other in each case in the peripheral region shown in FIG. 2. The casting cavity 4 extends into this region of overlap, in which the two metal layers 5, 6 thus overlap one another as seen vertically.

However, here, unlike in the prior art, the two metal layers 5, 6 do not bear against one another with direct contact. Instead, the two metal layers 5, 6 are thermally decoupled from one another. This is realized by virtue of the fact that an insulation element 21 is arranged on the second metal layer 6, said insulation element being embodied as a strip and consisting of a plastics material, especially a thermoplastic or an elastomer, and in particular of POM or a polyurethane elastomer. In the example, a stepped abutment surface 22, which bears the strip-like, cross-sectionally rectangular insulation element and to which the insulation element 21 is for example adhesively bonded, is formed on the metal layer 6. The insulation element 21 runs around the entire periphery, and it may consist of a plurality of element portions adjoining one another. For reception thereof, the abutment surface 22 is of stepped embodiment, such that an abutment edge 23 is formed, against which the insulation element 21 bears in the direction of the casting cavity 4.

The first mold part 22 also has an abutment surface 24 of stepped embodiment on the first metal layer 5. On the one hand, a first bearing region 25 is realized which forms a first raised region on which the insulation element 21 rests. A second bearing region 28 follows, separated by way of an encircling groove 26 in which a sealing element 27 in the form of a sealing cord or a sealing rubber or the like is received, said second bearing region, like the first receiving region 25, being of areal form but being slightly lower than the first receiving region 25. Accordingly, a defined height profile is formed on the bearing surface 24. The height difference between the first and second bearing region 25, 28 is for example 1 mm.

As shown in FIG. 3, in the further periphery profile, the second metal layer 6 is of angled embodiment and is supported on a support 29 of the second mold part carrier 11 by way of an insulating layer 30 and is clamped thereon by way of a clamping strip 31. In the example shown, a further clamping strip 32 is fastened to this clamping strip 31 and is used to peripherally clamp the insulation element 21, possibly also in addition to the adhesive bonding.

Correspondingly, in the further peripheral region, the first metal layer 5 is also of angled embodiment and is supported on a support 33 of the first mold part carrier 10 by way of an insulation 34.

If the casting mold 1 is closed, the upper second mold part 3 is moved vertically downward in the direction of the lower first mold part 2. Contact between the two mold parts 2, 3 occurs uniquely and solely in the peripheral region, and here also exclusively between the encircling insulation element 21 and the lower metal layer 5. As described, the insulation element 21 projects from the bearing surface 22 in the direction of the bearing surface 24 of the first metal layer 5. As the degree of lowering increases, the insulation element 21 first runs against the first bearing region 25 and at the same time also against the sealing element 27. As the lowering continues and the load acting on the insulation element 21 increases, the insulation element 21 is deformed to some extent, since it consists, as described, of a plastics material which has a certain degree of softness or elasticity. On account of the deformation, it then comes into abutment against the second bearing region 28. This means that it is supported in encircling fashion over a large area by way of the two bearing regions 25, 28, such that a large support surface is produced, which leads to a low surface pressure. The compressed sealing element 27 forms a further sealing plane in addition to the sealing of the casting cavity 4 by way of the insulation element 21 itself.

As shown in FIG. 3, in the closed position, there is accordingly no contact at any point between the two metal layers 5, 6. The two mold parts 2, 3 are connected to one another and, respectively, supported and sealed in relation to one another solely by way of the insulation element 21. In this case, the insulation element 21 also projects into the casting cavity 4 to a slight extent or delimits the latter, such that a corresponding spacing between the two metal layers 5, 6 is also provided virtually horizontally.

What is achieved by the thermal decoupling is that there is no heat transfer whatsoever between the two metal layers 5, 6 or no temperature compensation takes place, rather both metal layers are heatable individually and separately by way of the assigned heating devices 7, 8. This makes it possible for individual temperature profiles to be operated on the front side and rear side, as are required for the polymerization operation and the control thereof.

However, the insulation element 21 is used not only for thermal insulation but also for compensation of any unevennesses in the bearing surfaces or bearing regions. This is because, as described, the insulation element is elastic or flexible enough to be able to be adapted precisely to the respective shape of the bearing region, in particular of the first bearing region 25 in the direction of the casting cavity 4. Since the insulation element 21 is also pinched, a completely gap-free abutment is accordingly provided, meaning that no microgaps, which would lead to casting edges and the like that would require postprocessing, form in this region.

As also shown in FIG. 3, both on the part of the first heating device 7 and the second heating device 8, the heating elements 17 and 20, respectively, are laid more closely at the periphery than in those regions of the heating devices 7, 8 which adjoin thereto. This makes it possible to introduce a greater quantity of energy, that is to say more heat, into the polymer compound in the critical peripheral region, meaning that the metal layers 5, 6 and thus also the casting compound are heated more rapidly there compared with the rest of the surface. This therefore polymerizes to completion at the periphery sooner and more rapidly than within the rest of the volume. Since no movability of the second metal layer 6 resulting from the compression of the intermediate layer 9 is provided at the periphery, any shrinkage there cannot be compensated by such tracking of the metal layer 6. Since, however, the casting compound within the rest of the cavity volume is still liquid while it is already beginning to polymerize to completion at the periphery, the liquid casting compound accordingly pushes into the peripheral region, such that any shrinkage there is immediately compensated again by inflowing casting compound. This means that a defect-free periphery can be produced.

Beyond the compacted laying of the heating elements, the specific peripheral heating can also be individually designed such that the heating elements laid there can also be supplied with heating fluid or energized individually as separate heating circuit, such that a temporally different heating mode can also be effected, or for example can have a hotter fluid conducted therethrough or be more strongly energized, etc.

While specific embodiments of the invention have been shown and described in detail to illustrate the inventive principles, it will be understood that the invention may be embodied otherwise without departing from such principles.

We claim:

1. A casting mold for producing a casting having a front side and a rear side from a curable casting compound, comprising at least a first mold part shaping the front side and a second mold part shaping the rear side, said mold parts together delimiting a casting cavity, wherein the first mold part has a first metal layer delimiting the casting cavity and the second mold part has a second metal layer delimiting the casting cavity, wherein the two metal layers overlap in the region of their peripheries and at least the first metal layer is heatable by way of an assigned heating device, wherein an insulation element is arranged on the metal layer of the first or of the second mold part in a peripherally encircling manner, said insulation element in the closed position bearing peripherally against the other metal layer and thermally separating the two metal layers, which do not come into contact with one another, from one another.

2. The casting mold according to claim 1, wherein a heating device is also assigned to the second metal layer and can be used to heat the second metal layer separately.

3. The casting mold according to claim 1, wherein the insulation element supports the two metal layers in relation to one another.

4. The casting mold according to claim 1, wherein the insulation element consists of a material having a thermal conductivity<10 W/(m×K).

5. The casting mold according to claim 4, wherein the insulation element consists of a plastic.

6. The casting mold according to claim 5, wherein the insulation element is composed of POM or a polyurethane elastomer.

7. The casting mold according to claim 1, wherein the insulation element has a Shore A hardness of 80-100, in particular of Shore A 90.

8. The casting mold according to claim 1, wherein the insulation element is in the form of a strip and has a rectangular cross section.

9. The casting mold according to claim 1, wherein the insulation element is adhesively bonded to the metal layer and/or held thereon by way of one or more clamping elements.

10. The casting mold according to claim 1, wherein the peripheral region of the metal layer against which the insulation element is placed during the closing operation is of stepped embodiment, and has a first bearing region against which the insulation element first runs and a second bearing region against which the insulation element, pinched between the first bearing region and the metal layer bearing the insulation element, runs after the deformation thereof.

11. The casting mold according to claim 10, wherein the two bearing regions lie offset by 0.2-2 mm, in particular by 0.5 mm, relative to one another.

12. The casting mold according to claim 1, wherein an encircling sealing element which bears against the insulation element in the closed position is provided on the metal layer against which the insulation element runs during the closing operation.

13. The casting mold according to claim 10, wherein the sealing element is received in a groove between the first and the second abutment region.

14. The casting mold according to claim 1, wherein the, one of the two, or each areal heating device is arranged directly on the rear side of the respective metal layer and covers the rear side as far as the peripheral region of overlap.

15. The casting mold according to claim 1, wherein the, one of the, or each heating device has tubular or band-like heating elements which are embedded in a thermally conductive compound.

16. The casting mold according to claim 15, wherein the compound is an elastic thermally conductive compound.

17. The casting mold according to claim 15, wherein the heating elements of the or each heating device are laid more closely in the peripheral region of overlap than in the rest of the region, and/or in that a separately controllable heating circuit is provided in the peripheral region of overlap of the or each heating device.

18. The casting mold according to claim 1, wherein at least one metal layer is at least partially deformable for the purpose of changing the casting cavity volume.

19. The casting mold according to claim 18, wherein the mold part having the movable metal layer has an areal intermediate layer which is composed of an elastically deformable and compressible material and against which the metal layer of the mold part is movable with build-up of a restoring force on the part of the deforming intermediate layer.

20. The casting mold according to claim 19, wherein the intermediate layer is composed of an elastic and compressible plastics material.

21. The casting mold according to claim 20, wherein the intermediate layer is composed of foam rubber.

22. The casting mold according to claim 1, wherein the insulation element is designed with a non-adhering property in relation to the reaction compound.
